(19) United States
(12) Patent Application Publication
(10) Pub. No.: US 2015/0302755 A1
(43) Pub. Date: Oct. 22, 2015

(54) MEASUREMENT OF EDUCATIONAL CONTENT EFFECTIVENESS

(71) Applicant: GOOGLE INC., MOUNTAIN VIEW, CA (US)

(72) Inventors: Eric Leonard Breck, Cambridge, MA (US); Ashton Grimball, Ipswich, MA (US); Darren Curtis Meyer, Duxbury, MA (US); Margaret Louisa Benthall, Somerville, MA (US); Alan Huang, Cambridge, MA (US); Marshall Gillson, Somerville, MA (US); Eric David Scharff, Arlington, MA (US); Ian Helmke, Somerville, MA (US); William Bennett Brockman, Newton, MA (US); Paul Michael Litvak, Somerville, MA (US); Richard Daniel Borovoy, Boston, MA (US)

(73) Assignee: GOOGLE INC., MOUNTAIN VIEW, CA (US)

(21) Appl. No.: 14/258,490

(22) Filed: Apr. 22, 2014

(51) Int. Cl. G09B 5/12

(52) U.S. Cl. CPC G09B 5/12

(57) ABSTRACT

A method and system for evaluating the effectiveness of educational content is disclosed. An indicator of behavior of a user operating a user device is obtained. The indicator of the behavior of the user represents a usage of the user device by the user. An expected educational level of the user is obtained and a current educational skill level of the user is determined based on the indicator of the behavior of the user. The effectiveness of the educational content is evaluated based on a comparison of the current and expected educational skill levels of the user.

### BACKGROUND

1. Field of the Disclosure

The subject matter described herein relates generally to evaluating educational content and, more specifically, to evaluating educational software for mobile handheld devices.

2. Description of the Related Art

The proliferation of computing capabilities and developments in mobile handheld devices introduce various unconventional learning possibilities. For example, educational content (e.g., an application) implemented on a mobile handheld device such as a tablet may replace textbooks, and allows interactive content such as videos, quizzes, virtual tours, and the like to be integrated directly into the textbook. The interactive content can increase student engagement in the learning process as compared to a conventional learning environment.

A single mobile handheld device can store educational content or connect to the Internet to access the educational content in the cloud, allowing the learning experience to extend outside of the classroom. Additionally, a teacher may assign projects to students through the mobile handheld devices, and the students may interactively communicate and participate in a class activity with the mobile handheld devices.

Despite the new educational model stemming from the development of educational content tailored to mobile handheld devices, current systems lack an evaluation system to measure the effectiveness of such educational content. Recommendations provided by other educators or users may be biased, and do not give a reliably objective measure of the effectiveness of the educational content. Hence, it is difficult for school administrators, teachers, or parents to quantitatively measure the value of adopting the new educational model against the cost associated with obtaining and maintaining the necessary hardware and software. Additionally, it is difficult for the school administrators to compare and select which educational content items to implement from the myriad of such content available. Moreover, it is difficult for an application generator to observe important factors in developing effective educational content.

### SUMMARY

Embodiments of the present disclosure include a system and method for evaluating effectiveness of an educational content item for a user device, such as a mobile handheld device. The system and method evaluates the effectiveness of the educational content item based on behavior of a user operating the user device.

In one embodiment, the method of evaluating effectiveness of an educational content item includes obtaining an indicator of behavior of a user operating a user device, the indicator of the behavior of the user representing a usage of the user device by the user. In addition, the method includes determining a current educational skill level of the user based on the indicator of the behavior of the user. Further, the method includes determining an expected educational skill level of the user had the user not accessed the educational content item. Furthermore, the method includes generating a measure of the effectiveness of the educational content item based on the educational skill level of the user and the expected educational skill level of the user.

In one embodiment, an educational content evaluator system includes a user device operated by a user to access an educational content item. The educational content evaluator system also includes a content generator including a content generator interface module to generate the educational content item. The educational content evaluator system includes a behavior analysis module to identify an educational level of the user. The behavior analysis module includes a behavior extraction module to obtain an indicator of behavior of the user. The indicator of the behavior of the user represents a usage of the user device by the user. The behavior analysis module also includes an educational skill level identifier module. The educational skill level identifier module determines an educational skill level of the user based on the indicator of the behavior of the user. Moreover, the educational content evaluator system includes an application effectiveness analysis module to evaluate the effectiveness of the educational content item based on the educational skill level of the user.

The features and advantages described in this summary and the following detailed description are not all-inclusive. Many additional features and advantages will be apparent to one of ordinary skill in the art in view of the drawings, specification, and claims presented herein.

### BRIEF DESCRIPTION OF THE DRAWINGS

FIG. 1 is a high level block diagram of an educational content evaluation system, in accordance with an embodiment.

FIG. 2 is a block diagram of a user device suitable for use in the system shown in FIG. 1, in accordance with an embodiment.

FIG. 3 is a block diagram of the content controller shown in FIG. 1, in accordance with an embodiment.

FIG. 4 is a block diagram of the content generator shown in FIG. 1, in accordance with an embodiment.

FIG. 5 is a block diagram of a behavior analysis module in the user device, content controller, or content generator shown in FIG. 1, in accordance with an embodiment.

FIG. 6 is a block diagram illustrating an example of a computer suitable for use as a user device, content controller, or content generator shown in FIG. 1, in accordance with an embodiment.

FIG. 7 is a flow chart illustrating a method of measuring effectiveness of an educational content item, in accordance with an embodiment.

FIG. 8 is a flow chart illustrating a detailed method of evaluating the effectiveness of an educational content item based on the current educational skill levels of users and the expected educational skill levels of those users had they not accessed the educational content item, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Embodiments of various systems, methods, and computer-readable storage media that enable evaluating the effectiveness of an educational content item for mobile handheld devices are described below. Various embodiments evaluate the effectiveness of the educational content item by analyzing an indicator of a user's behavior while operating a user device. The indicator of the user's behavior is applied to a statistical attribution model to determine an educational skill level of the user. Furthermore, the effectiveness of the educational content item is in some applications evaluated based on the educational skill level of the user and a performance of the user while using the educational content item or other content on the user device. Moreover, the effectiveness of the educational content item is in some applications compared against the effectiveness of other educational content items.

As used herein, the behavior of the user refers to activities or usages of a user device (e.g., a mobile handheld device) by the user. The behavior may include activities related to the educational content item in addition to activities unrelated to the educational content item. For example, activities related to the educational content item may include time spent on a particular subject or performance on a quiz, and activities unrelated to the educational content item may include an amount of time and frequency spent accessing particular non-educational content, a type of an application that is frequently used, or rates at which the user performs tasks such as reading, typing, and the like.

### Educational Content Evaluation System

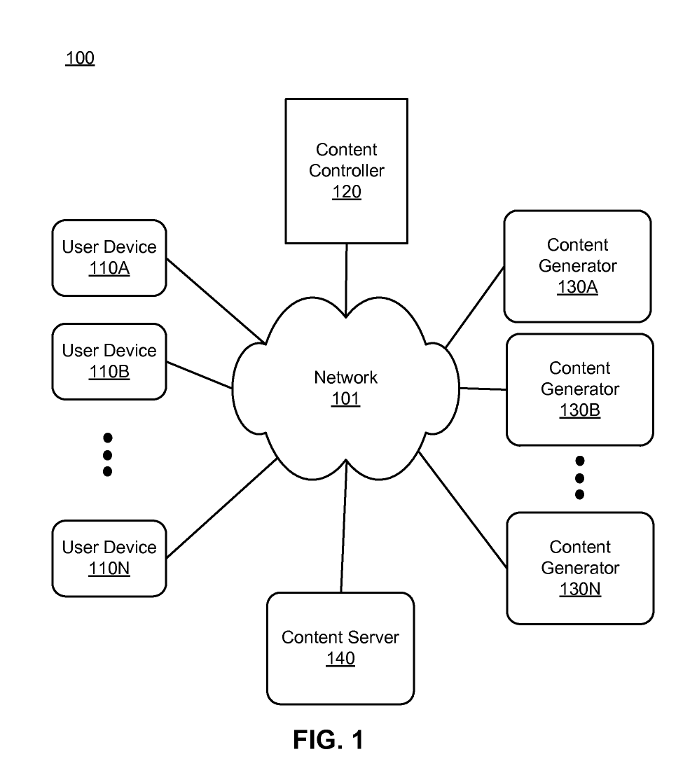

FIG. 1 is an illustration of an educational content evaluation system 100 in accordance with one embodiment. The educational content evaluation system 100 includes a plurality of user devices 110A-N (generally referred to as a user device 110), that are coupled to a network 101. The educational content evaluation system 100 also includes a content controller 120, a plurality of content generators 130A-N (generally referred to as a content generator 130), and a content server 140, that are coupled to the network 101. In other embodiments, the system 100 contains different or additional elements. In addition, the functions may be distributed among the elements in a different manner than described herein.

In various embodiments, the user device 110 may include any computing device capable of accessing an educational content item, such as a personal digital assistant (PDA), a smart phone, a tablet personal computer, a desktop computer, and the like. In one specific embodiment, the user device 110 is a smart phone or a tablet personal computer operating on Android™ operating system provided by Google Inc. In another specific embodiment, the user device 110 is an iPhone® or iPad® device provided by Apple Inc. The user device 110 is, in some particular embodiments, programmed with a user-downloadable application providing one or more of the functions described herein.

In various embodiments, the network 101 may include, but is not limited to, a local area network (LAN), a wide area network (WAN), a wireless network, an intranet, or the Internet.

In one embodiment, a content generator 130 generates educational content and uploads the educational content to one or more content servers 140. The user device 110 or the content controller 120 receives the educational content from the content server 140. Alternatively, the user device 110 receives educational content from the content controller 120. The content controller 120 may grant or control the user device 110 access to the educational content, depending on the specific environment of use.

The user device 110 accesses the educational content, and the content controller 120 or the content generator 130 monitors the progress or performance of the user operating the user device 110 with regards to the educational content. In one embodiment, the content controller 120 or the content generator 130 monitors activities of the user device 110, and analyzes behavior of the user of the user device 110. For example, the content controller 120 or the content generator 130 may store user behavior data indicating a number of tasks completed or a number of questions answered correctly. Furthermore, the content controller 120 or the content generator 130 may analyze the effectiveness of the educational content based on the user behavior data.

In situations in which the systems discussed here collect personal information about users, or may make use of personal information, the users operating the user devices 110 may be provided with an opportunity to control whether programs or features collect user information (e.g., information about a user's social network, social actions or activities, profession, a user's preferences, or a user's current location), or to control whether or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

In one embodiment, the content server 140 stores the educational content, progress and performance records of the user of the user device 110, and effectiveness data indicating the effectiveness of the educational content. The content controller 120 may manage access of the user device 110 to the educational content, if required. In other embodiments, the user device 110 or the content controller 120 itself stores the educational content, performances records of the user of the user device 110, and effectiveness data.

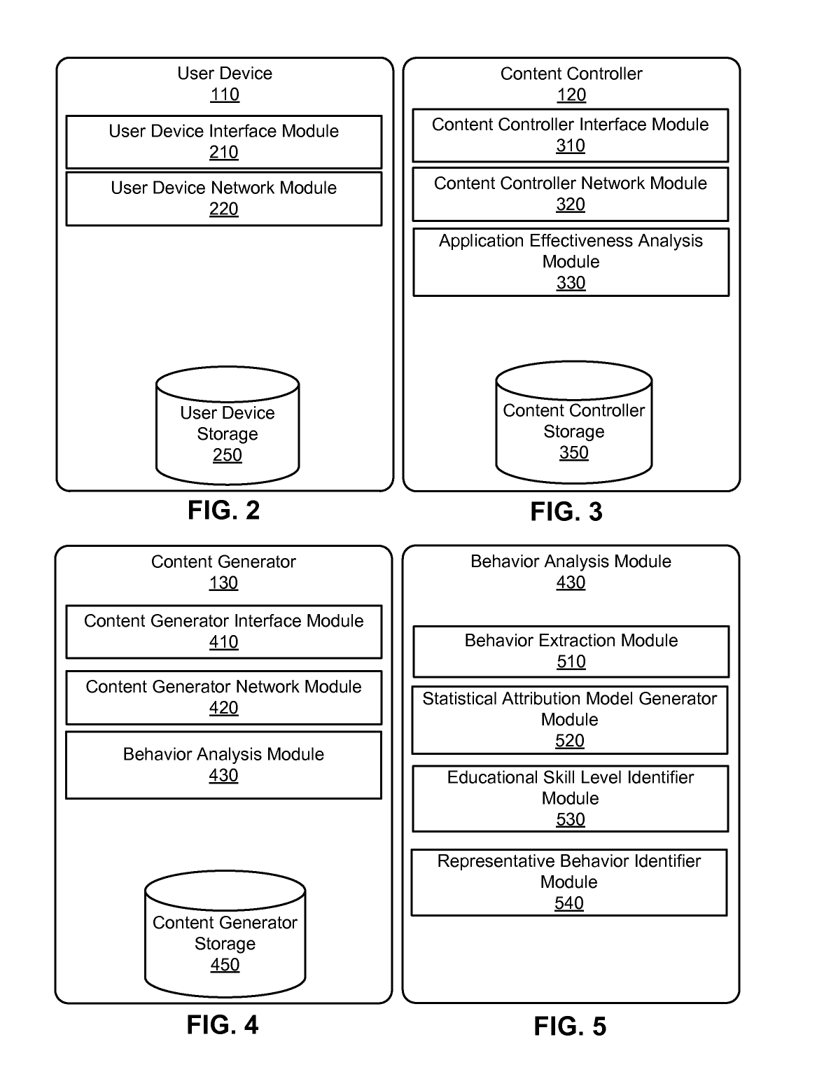

FIG. 2 is a block diagram of a user device 110, in accordance with an embodiment. The user device 110 is operated by a user (e.g., a student). The illustrated user device 110 includes a user device interface module 210, a user device network module 220, and user device storage 250. In other embodiments, the user device 110 contains different or additional elements. In addition, the functions may be distributed among the elements in a different manner than described herein. For example, the user device 110 may include a behavior analysis module 430 described herein in detail with respect to FIG. 5. The user device 110 may also include an application effectiveness analysis module 330 described herein in detail with respect to FIG. 3.

The user device interface module 210 enables the user to access educational content on the user device 110. The user device interface module 210 provides for the display of educational content to the user. Additionally, the user device interface module 210 provides user controls to enable the user to input commands to access and interact with educational content. The educational content may include, but is not limited to, text, audio, video, and interactive content. The interactive content may include a game, quiz, live discussion, or group project that requires user input. For example, the user may read a chapter of an electronic book on a tablet in a U.S. history class, and be given an option to play a video about Congress Hall in Philadelphia.

The user device interface module 210 also enables the user to access non-educational content. For example, the user may browse the Internet, check emails, watch a movie, read a novel, or play a game through the user device interface module 210. Additionally, the user device interface module 210 may provide an interface for viewing the effectiveness scores of various educational content items, e.g., those generated by the application effectiveness analysis module 330, as described below with reference to FIG. 3. An effectiveness score of an educational content item represents a quantitative representation of the effectiveness of the educational content item.

The user device network module 220 of the user device 110 enables the user device 110 to connect to the network 101, and manages communication between the user device 110 and the content controller 120, content generator 130, or content server 140. In one embodiment, the user device network module 220 of the user device 110 receives instructions or commands from the content controller 120. Under permission from the content controller 120 (if required), the user device network module 220 of the user device 110 retrieves the educational content from the content server 140 or the content controller 120. In one embodiment, with consent from the user of the user device 110 or the guardian of the user (if required), the user device network module 220 transmits user information to the content controller 120, content generator 130, or content server 140. In addition, the user device 110 may communicate with the content controller 120 or another user device 110 through the user device network module 220 to facilitate group work, such as sharing responses to interactive content, participating in a group discussion, and the like.

In one embodiment, the user device 110 stores user information in the user device storage 250. The user information may include, but is not limited to, progress and performance in the educational content, a user profile, and user behavior logs. The user profile may include age, gender, class level, and educational skill level of the user (e.g., a reading level, a degree of proficiency in geometry, or a state of proficiency in a foreign language). In addition, under permission from the content controller 120 if required, the user device 110 may store educational content in conjunction with corresponding progress data in the user device storage 250.

The user device storage 250 comprises one or more non-transitory computer-readable storage media, such as a hard drive, flash memory, and the like. The user device storage 250 is configured to store data pertinent to the operation of the other modules of the user device 110.

FIG. 3 is a block diagram of a content controller 120 suitable for use in the educational content evaluation system 100, in accordance with an embodiment. The content controller 120 may be used by a teacher when the system 100 is in operation or may be operated by an educational content service provider. The illustrated content controller 120 includes a content controller interface module 310, a content controller network module 320, an application effectiveness analysis module 330, and content controller storage 350. In other embodiments, the content controller 120 contains different or additional elements. In addition, the functions may be distributed among the elements in a different manner than described herein. For example, the content controller 120 may include a behavior analysis module 430 described herein in detail with respect to FIG. 5. In addition, some or all of the functionality attributed to the application effectiveness analysis module 330 may be provided by a user device 110 or a content generator 130.

In some embodiments, the content controller 120 is similar to the user devices 110. Hence, the content controller network module 320 and the content controller storage 350 may be similar to the user device network module 220 and the user device storage 250 in the user device 110, respectively.

In various embodiments, one difference between the content controller 120 and the user devices 110 is the inclusion of the content controller interface module 310. The content controller interface module 310 enables the content controller 120 to control access of the user device 110 to resources. The content controller 120 may limit access of the user device 110 to certain educational content or non-educational content. For example, using the content controller interface module 310, a teacher may limit access of students operating the user devices 110A-N to educational content pertinent to a group task included in the lesson plan. In addition, the content controller interface module 310 enables the content controller 120 to monitor and control communication among the plurality of user devices 110A-N, the content controller 120, and the content server 140. The content controller 120 may monitor progress and performance of the students operating the user devices 110A-N in the educational content, via the content controller interface module 310. The content controller 120 may also view indicators of behaviors of users (e.g., students), educational skill levels, expected achievement values, and representative behaviors via the content controller interface module 310. In one embodiment, the content controller 120 and the user device 110 are implemented in a same or similar system. A given user device 110 may employ the content controller interface module 310 and operate as the content controller 120 on an ad hoc basis (e.g., based on which device is logged into by a class teacher).

In one embodiment, the application effectiveness analysis module 330 of the content controller 120 determines a measure of effectiveness of an educational content item being used based on the educational skill level of the user (whether predicted or predetermined) and the performance of the user when using the educational content item. The application effectiveness analysis module 330 compares a performance of the users of corresponding user devices 110A-N when using the educational content item with an expected achievement value based on the educational skill level of the users.

In various embodiments, the application effectiveness analysis module 330 generates an effectiveness score of the educational content item based on the comparison of the performance of the users and the expected achievement value. In one such embodiment, the application effectiveness analysis module 330 determines a difference between the expected achievement value and the performance of each user and compares the average difference to a linear scale to generate the effectiveness score of the educational content item. In another such embodiment, the application effectiveness analysis module 330 performs a statistical analysis by fitting a Gaussian curve to the users' performances to generate an effectiveness score of the educational content item. Furthermore, the application effectiveness analysis module 330 may compare the effectiveness score of the educational content item with effectiveness scores of other educational content items to determine a relative effectiveness of the educational content item.

FIG. 4 is a block diagram of a content generator 130, in accordance with an embodiment. The content generator 130 is used by an educational content developer. In the illustrated embodiment, the content generator 130 includes a content generator interface module 410, a content generator network module 420, a behavior analysis module 430, and content generator storage 450. In other embodiments, the content generator 130 contains different or additional elements. In addition, the functions may be distributed among the elements in a different manner than described herein. For example, the content generator 130 may include an application effectiveness analysis module 330 described above in detail with respect to FIG. 3. In addition, some or all of the functionality attributed to the behavior analysis module 430 may be provided by a user device 110 or a content controller 120.

In some embodiments, the content generator 130 is similar to the content controller 120. Hence, the content generator network module 420 and the content generator storage 450 may be similar to the content controller network module 320 and the content controller storage 350 in the content controller 120, respectively.

In various embodiments, one difference between the content generator 130 and the content controller 120 is the inclusion of the content generator interface module 410. The content generator interface module 410 includes an application programming interface (API) for developing educational content. In addition, under permission from the user device 110 and the content controller 120, the content generator interface module 410 enables the content generator 130 to monitor the progress and performance of the students when using educational content. The content generator interface module 410 may enable the content generator 130 to track indicators of behaviors of users (e.g., students), educational skill levels, expected achievement value, and representative behaviors. Hence, the content generator interface module 410 may enable application developers to develop or update educational content items based on indicators of user behaviors suggesting that particular content is particularly effective (e.g., by providing similar content in other applications) or ineffective (e.g., by replacing the ineffective content).

The behavior data collector module 430 of the content generator 130 identifies a current educational skill level of the user based on the behavior of the user of the user device 110. In one embodiment, the behavior analysis module 430 examines the usage of the user device 110 under the consent from the user of the user device 110 or the guardian of the user (if required), and obtains an indicator of the behavior of the user representing the usage of the user device 110. For instance, the indicator of the behavior of the user may be a length of time spent reading news articles every day and corresponding reading levels of the news articles. As other examples, the indicator of the behavior of the user may be a length of time spent on solving a linear algebra problem and an indication of a corresponding indication of difficulty of the problem, a length and frequency of listening to classical music, and the like. In one embodiment, the behavior analysis module 430 predicts an educational skill level of the user by applying a statistical attribution model to one or more indicators of user behavior, as described below with reference to FIG. 5. Different observed behaviors may be associated with different degrees of certainty in the resulting predicted educational level for the user. In another embodiment, a predetermined educational skill level of the user is retrieved from the network 101 (e.g., from content server 140 or user device storage 250), such as one determined by previous tests, examinations, classes taken, and the like.

FIG. 5 is a block diagram illustrating in detail the behavior analysis module 430 of the user device 110, in accordance with an embodiment. The illustrated behavior analysis module 430 includes a behavior extraction module 510, a statistical attribution model generator module 520, an educational skill level identifier module 530, and a representative behavior identifier module 540. In other embodiments, the behavior analysis module 430 contains different or additional elements. In addition, some elements may be omitted or the functions may be distributed among the elements in a different manner than described herein.

The behavior extraction module 510 generates an indicator of behavior of a user based on activities performed on the user device 110. The indicator of behavior of the user represents activities or usage of the user device 110 by the user. The usage may be related to the educational content, non-educational content, or both. For example, the indicator of the behavior may include the time and frequency spent using a particular application. As another example, the indicator of the behavior may include indicators of the types of applications used by the user or a predetermined reading level of the (educational or non-educational) application executed on the user device 110. In one embodiment, the behavior extraction module 510 analyzes words or other content included in applications to automatically determine an educational level for the application.

The statistical attribution model generator module 520 builds a statistical attribution model. The statistical attribution model generator module 520 aggregates progress and performances of users when using educational content, indicators of behaviors of those users, and (optionally) user profiles of those users. The statistical attribution model generator module 520 performs a statistical analysis to generate a statistical attribution model that identifies correlations among the indicators of the behaviors and the performances when using the educational content, and (optionally) correlations between features within the user profiles and certain behaviors or performance levels. The statistical attribution model may be developed by using supervised machine learning techniques (e.g., support vector machines, neural networks, etc.) to train models to predict outcomes based on the features extracted. According to the statistical attribution model, the effectiveness of different questions or parts of an educational content may be determined.

The educational skill level identifier module 530 applies the statistical attribution model to determine the educational skill level of individual users. Specifically, the educational skill level identifier module 530 applies an indicator of behavior of the user to the statistical attribution model, which provides an estimate of the educational skill level of the user based on a correlation between the observed behavior and the predicted skill level. For example, the statistical attribution model generator module 520 may identify that users with a sixth grade reading level read a particular book at a rate of one page every seventy seconds, while those at a fifth grade level require two whole minutes per page. Consequently, if a particular user progresses through the book at a rate of seventy-two seconds per page, that user is likely to be predicted as having a sixth grade reading level. In contrast, a user who takes around one hundred seconds a page may be predicted to be reading at a fifth grade level. One of skill in the art will appreciate that numerous correlations may be recognized between observable behaviors and the user's level with regards to a corresponding skill.

The representative behavior identifier module 540 performs a reverse process from the educational skill level identifier module 530, and determines one or more representative indicators of the behavior of the user that provide a reliable prediction regarding educational level or performance within a particular application. The representative behavior identifier module 540 receives a plurality of indicators of behaviors of the user and applies them to the statistical attribution model to determine one or more representative indicators that exhibit a strong correlation with a known skill level or performance. In one embodiment, the representative behavior identifier module 540 selects as the representative indicator the behavior indicator with the highest correlation with known skill levels stored in user profiles. Alternatively, the representative behavior identifier module 540 constructs a set of representative indicators comprising indicators of behaviors with correlations above a threshold value. The threshold value may be predetermined, or may be adjusted by a user (e.g., an application developer looking to identify behaviors to monitor within a new application). Indicators of behaviors of the user with a low correlation to known levels may be ignored, and thus a set of representative indicators that predicts the educational skill level of the user with a high degree of certainty may be identified and later applied by the educational skill level identifier module 530.

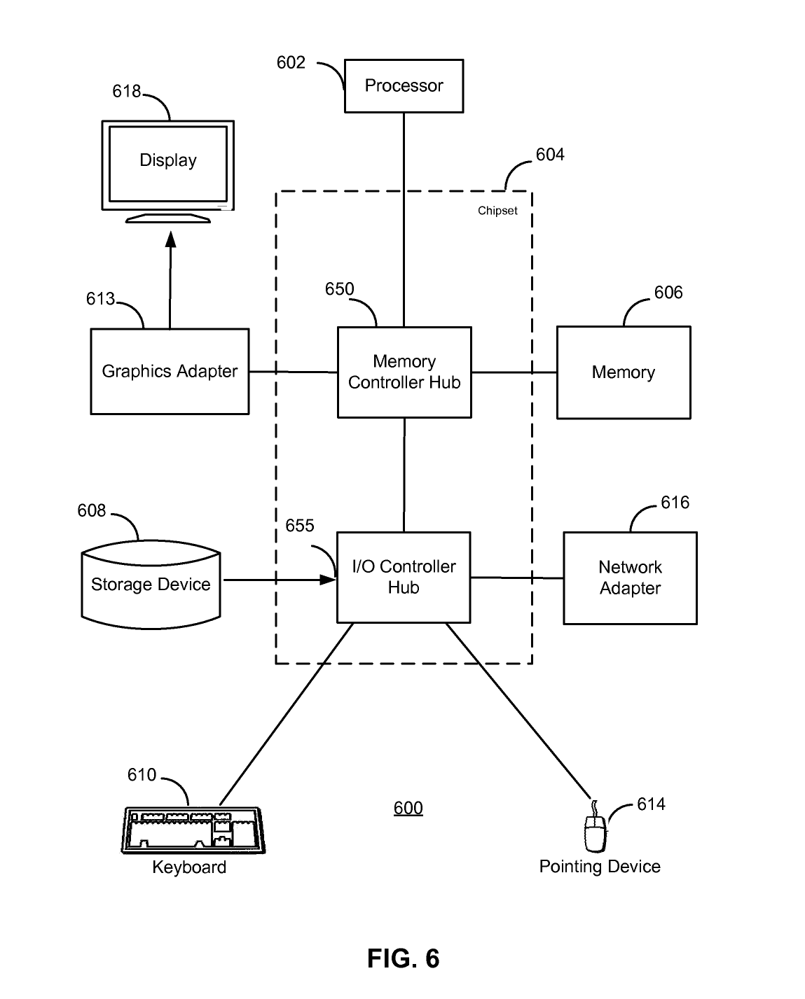

FIG. 6 is high level block diagram illustrating an example of a computer 600 for use as a user device 110, a content controller 120 or a content server 140, in accordance with an embodiment of the routing system. Illustrated are at least one processor 602 coupled to a chipset 604. The chipset 604 includes a memory controller hub 650 and an input/output (I/O) controller hub 655. A memory 606 and a graphics adapter 613 are coupled to the memory controller hub 650, and a display device 618 is coupled to the graphics adapter 613. A storage device 608, keyboard 610, pointing device 614, and network adapter 616 are coupled to the I/O controller hub 655. Other embodiments of the computer 600 have different architectures. For example, the memory 606 is directly coupled to the processor 602 in some embodiments.

The storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, or other type of pointing device, and in some embodiments is used in combination with the keyboard 610 to input data into the computer 600. The graphics adapter 613 displays images and other information on the display device 618. In some embodiments, the display device 618 includes a touch screen capability for receiving user input and selections and is connected to the I/O controller hub 655. The network adapter 616 couples the computer 600 to the network 101. Some embodiments of the computer 600 have different or other components than those shown in FIG. 6.

The computer 600 is adapted to execute computer program modules for providing functionality described herein. As used herein, the term “module” refers to computer program instructions and other logic used to provide the specified functionality. Thus, a module can be implemented in hardware, firmware, or software. In one embodiment, program modules formed of executable computer program instructions are stored on the storage device 608, loaded into the memory 606, and executed by the processor 602.

The types of computers 600 used by the entities of FIG. 1 can vary depending upon the embodiment and the processing power used by the entity. For example, the user device 110 or the content controller 120 that is a PDA or a handheld mobile device typically has limited processing power, a small display device 618, and might lack a pointing device 614. In one embodiment, the user device 110 is capable to act as a content controller 120 when needed. The content generator 130 or the content server 140, in contrast, may comprise multiple blade servers working together to provide the functionality described herein. Alternatively, the content controller 120 or the content generator 130 is a personal computer and may be combined with the content server 140.

### Exemplary Method of Evaluating Educational Content

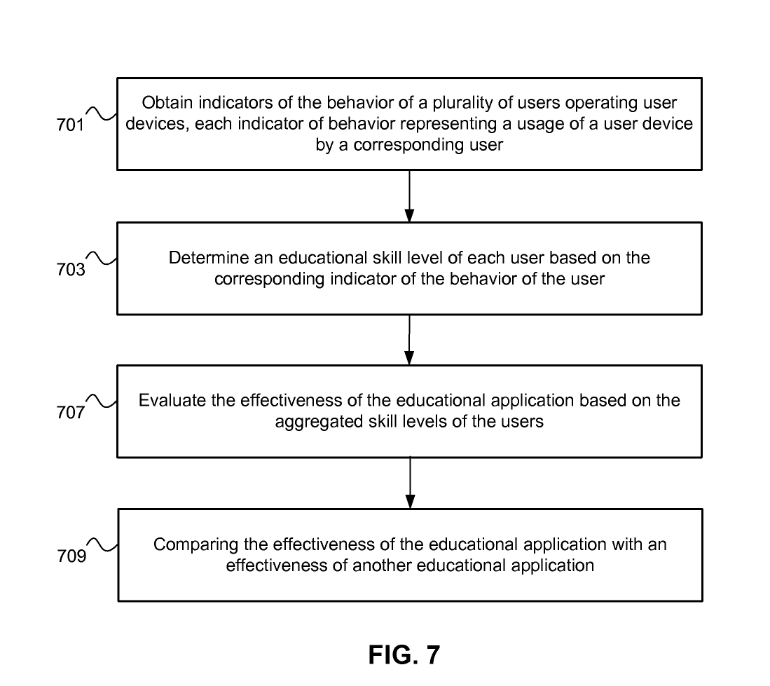

FIG. 7 is a flow chart illustrating a method of evaluating an effectiveness of an educational content item, in accordance with an embodiment. The steps of FIG. 7 are described from the perspective of a content controller 120 performing the method. However, some or all of the steps may be performed by other entities or components. For example, a user device 110 or a content generator 130 may perform the disclosed method. In addition, some embodiments may perform the steps in parallel, perform the steps in different orders, or perform different steps.

In the illustrated embodiment, a content controller 120 obtains 701 an indicator of behavior of a user operating a user device 110. The indicator of the behavior of the user represents a usage of the user device 110 by the user. In addition, the content controller 120 determines 703 an educational skill level of the user based on the indicator of the behavior of the user.

Additionally, the content controller 120 evaluates 707 the effectiveness of the educational content item based on the determined educational skill levels of the users and corresponding expected educational levels of the users. In one embodiment, the expected skill level for a user is determined from a statistical expectation based on information stored in the user's user profile (e.g., age, previous test scores, etc.). In another embodiment, the expected skill level for a user is determined by monitoring one or more indicators of behavior for the user prior to using the educational content item. In some embodiments, the content controller 120 compares 709 the effectiveness of the educational content item with the effectiveness of other educational content items to determine a relative effectiveness.

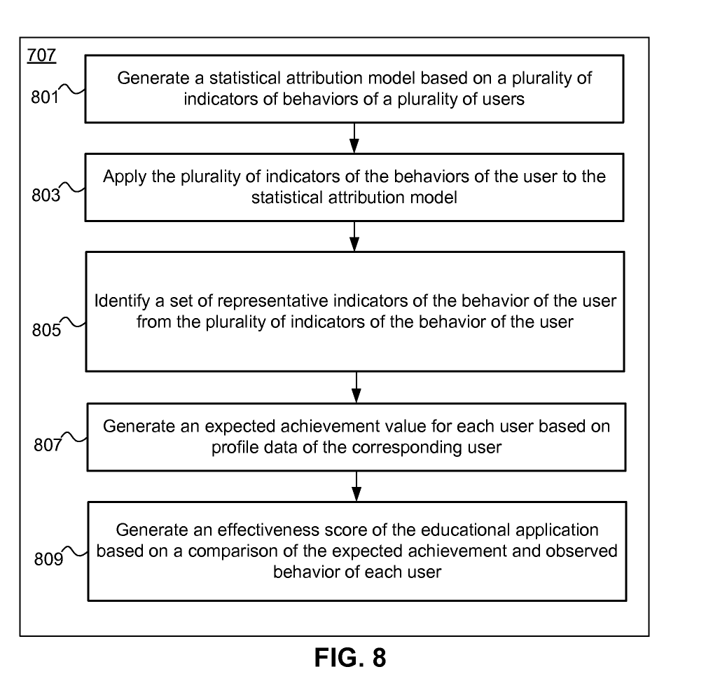

Referring to FIG. 8, illustrated is a flow chart illustrating step 707 of FIG. 7 in detail, in accordance with an embodiment. The steps of FIG. 8 may be performed by the behavior analysis module 430 and the application effectiveness analysis module 330 employed in a user device 110, content controller 120 or content generator 130. However, some or all of the steps may be performed by other entities or components. In addition, some embodiments may perform the steps in parallel, perform the steps in different orders, or perform different steps.

In the illustrated method, the behavior analysis module 430 generates 801 a statistical attribution module based on a plurality of indicators of behaviors of a plurality of users. The behavior analysis module 430 applies 803 the plurality of indicators of the behaviors of the user operating the user device 110 to the statistical attribution model in order to identify 805 a set of one or more representative indicators of the behavior of a user from the plurality of indicators. Additionally, the application effectiveness analysis module 330 generates 807 an expected achievement value for each user based on profile data of the corresponding user (e.g., prior test scores, age, previously observed behavior, etc.). Furthermore, the application effectiveness analysis module 330 generates 809 an effectiveness score of the educational content item based on a comparison of the expected achievement and the observed behavior of each user. For example, if students are expected to advance one grade level in mathematics over a one year period without the use of a new educational application, the expected achievement for each student may be one grade level above their previously determined level. This expected performance can be compared to the actual performance of the students at the end of the year after making use of the new educational application to determine how effective the application was in improving the students' math skills. The previous and actual performances of the students can be determined from test scores or analysis of behaviors that the statistical attribution model generator module 520 has identified correlate with a student's grade level in mathematics. In some embodiments, a single indicator of behavior may be all that needs to be tracked for a given purpose, while in other applications several different indicators may be used to reliably gauge performance or otherwise track improvement.

With the disclosed system and method, an educational skill level of a user operating the user device 110 may be inferred based on behavior of the user. For example, the user device 110 may track search queries of a student. By performing a statistical analysis on the tracked search queries, the behavior analysis module 430 determines that that the student is able to use dependent clauses and that the vocabulary level is at the level of a 6th grader. Furthermore, the behavior analysis module 430 may draw an inference on the ability for the student to understand a piece of argumentative writing from educational skill level identifier module 530.

With the disclosed system and method, representative behaviors of a user may be identified based on behavior of the user. For example, the user device 110 may record performances of the user in a math learning application. By applying statistical analysis on the performances of the user, the behavior analysis module 430 identifies a pattern of mistakes, where a student makes mistakes with long division. Further, the behavior analysis module 430 may draw an inference that the problem lies with understanding of decimal places.

Beneficially, the disclosed configurations provide objective measures of the effectiveness of educational content. As a result, school administrators, teachers, parents, and guardians can assess the value of implementing the mobile handheld devices in the classroom, and determine effective uses of such educational content. Moreover, a teacher or a student may monitor progress and performance when using educational content based on the behavior of the student when interacting with a user device. Furthermore, a content creator may observe representative behaviors of students and generate or update educational content accordingly. The configurations disclosed herein are in the context of educational content accessed via mobile handheld devices. However, the principles disclosed herein can apply to any hardware or software designs that can analyze behavior of a user and perform statistical analyses to identify correlations between educational achievement and use of particular educational content items.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs executed by a processor, equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise. Upon reading this disclosure, those of skill in the art will appreciate still additional alternative structural and functional designs for a system and a method for evaluating educational content through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method of evaluating an effectiveness of an educational content item, the method comprising:
obtaining an indicator of behavior of a user operating a user device, the indicator representing a usage of the user device by the user;
determining a current educational skill level of the user based on the indicator;
determining an expected educational skill level of the user had the user not accessed the educational content item; and
generating a measure of the effectiveness of the educational content item based on a comparison of the current educational skill level of the user and the expected educational skill level of the user.

2. The method of claim 1, further comprising:
comparing the effectiveness of the educational content item with an effectiveness of another educational content item to generate a relative effectiveness measure.

3. The method of claim 1, further comprising:
monitoring the indicator; and
identifying, based on the indicator, a correlation between a feature of the educational content item and an improvement in an educational skill level of the user.

4. The method of claim 3, further comprising:
updating, at a content generator, the educational content item based on the correlation.

5. The method of claim 3, further comprising:
generating, at a content generator, another educational content item based on the correlation.

6. The method of claim 1, further comprising:
generating a statistical attribution model based on a plurality of indicators of behaviors of other users operating other user devices.

7. The method of claim 6, wherein determining the current educational skill level comprises:
applying the indicator of claim 1 to the statistical attribution model.

8. The method of claim 6, further comprising:
determining one or more representative indicators from the plurality of indicators, the one or more representative indicators being correlated with an educational skill level of the user.

9. The method of claim 1, wherein determining the expected educational skill level of the user comprises:
monitoring, prior to use of the educational content item, a second indicator of behavior of the user; and
determining the expected educational skill level of the user based on the second indicator of behavior.

10. The method of claim 1, further comprising:
generating an effectiveness score of the educational content item based on the evaluation of the effectiveness of the educational content item; and
comparing the effectiveness score of the educational content item and an effectiveness score of another educational content item to calculate a relative effectiveness score.

11. The method of claim 1, wherein the usage of the user device comprises usage of the educational content item and usage of a non-educational content item.

12. An educational content evaluator system comprising:
a user device operated by a user and configured to access an educational content item;
a content generator comprising a content generator interface module configured to generate the educational content item for provision on the user device;
a behavior analysis module configured to identify an educational skill level of the user, the behavior analysis module comprising:
a behavior extraction module configured to obtain an indicator of behavior of the user, the indicator of the behavior of the user representing a usage of the user device by the user, and
an educational skill level identifier module configured to determine a current educational skill level of the user based on the indicator of the behavior of the user; and
an application effectiveness analysis module configured to:
evaluate the effectiveness of the educational content item based on the current educational skill level of the user.

13. The educational content evaluator system of claim 12, further comprising:
a content controller comprising a content controller interface module configured to monitor the indicator of the behavior of the user.

14. The educational content evaluator system of claim 13, wherein at least one of the user device, the content controller, and the content generator comprises the behavior analysis module.

15. The educational content evaluator system of claim 13, wherein at least one of the content controller and the content generator comprises the application effectiveness analysis module.

16. The educational content evaluator system of claim 12, wherein the content generator interface module is further configured to:
monitor the indicator of the behavior of the user; and
generate an educational content update based on the indicator of the behavior of the user.

17. The educational content evaluator system of claim 12, wherein the behavior analysis module further comprises a statistical attribution model generator module configured to generate the statistical attribution model, the educational skill level identifier module configured to determine the current educational skill level of the user by applying the indicator of the behavior of the user to the statistical attribution model.

18. The educational content evaluator system of claim 17, wherein the behavior analysis module further comprises:
a representative behavior identifier module configured to determine a set of one or more representative indicators of the behavior of the user from a plurality of indicators of behaviors, the one or more representative indicators of the behavior of the user being correlated with an educational skill level of the user.

19. The educational content evaluator system of claim 12, wherein the application effectiveness analysis module is further configured to:
determine an expected educational skill level for the user had the user not used the educational content item, and
compare the current educational skill level with the expected educational skill level, the effectiveness of the educational content item being based on a difference between the expected educational skill level and the current educational skill level.

20. The educational content evaluator system of claim 19, wherein the application effectiveness analysis module determines the expected educational level by being configured to:
monitor, prior to use of the educational content item, a second indicator of behavior of the user; and
determine the expected educational skill level of the user based on the second indicator of behavior.
